(19) United States
(12) Patent Application Publication
(10) Pub. No.: US 2014/0341318 A1
(43) Pub. Date: Nov. 20, 2014

(54) AVERAGE POWER TRACKING IN A TRANSMITTER

(71) Applicant: Broadcom Corporation, Irvine, CA (US)

(72) Inventors: Mohsen Pourkhaatoun, Laguna Niguel, CA (US); Dmitriy Rozenblit, Irvine, CA (US); Masoud Kahrizi, Irvine, CA (US); Alireza Tarighat Mehrabani, Laguna Beach, CA (US)

(21) Appl. No.: 13/913,327

(22) Filed: Jun. 7, 2013

Related U.S. Application Data
(60) Provisional application No. 61/824,287, filed on May 16, 2013.

(51) Int. Cl. H04B 1/04

(52) U.S. Cl. CPC H04B 1/0475
USPC 375/297

(57) ABSTRACT

Average Power Tracking (APT) is a technique that can be utilized for vary the supply voltage to a power amplifier (PA) on a timeslot basis in order to reduce power consumption of the PA. Systems and methods are provided for maximizing power savings associated with the PA by utilizing APT in a continuous and aggressive manner. Additionally, the systems and methods can further compensate for variations in temperature, frequency, antenna load, and peak to average power ratio (PAPR) without sacrificing the power savings.

### TECHNICAL FIELD

The technical field of the present disclosure relates to wireless communication systems, and more particularly, to utilizing average power tracking (APT) to dynamically adjust and/or optimize supply voltages provided to a power amplifier (PA) of a transmitter.

### BACKGROUND

Communication systems may support wireless and wireline communications between wireless and/or wireline communication devices. Each type of communication system may be constructed/configured to operate in accordance with one or more communication standards. For instance, wireless communication systems may operate in accordance with one or more standards including, but not limited to, Radio Frequency Identification (RFID), Institute of Electrical and Electronic Engineers (IEEE) 802.11, Bluetooth®, advanced mobile phone services (AMPS), digital AMPS, Global System for Mobile Communications (GSM)/2G, General Packet Radio Service (GPRS)/2.5G, Enhanced Data for GSM Evolution (EDGE)/3G, code division multiple access (CDMA), wideband CDMA (WCDMA), CDMA2000, Long Term Evolution (LTE or 4G LTE), WiMAX, local multi-point distribution systems (LMDS), multi-channel-multi-point distribution systems (MMDS), and/or variations thereof.

Wireless/mobile communication devices, or “mobile devices”, such as cellular telephones, two-way radios, personal digital assistants (PDAs), personal computers (PCs), laptop computers, home entertainment equipments, radio frequency identification (RFID) readers, RFID tags, etc. may communicate directly or indirectly with other mobile devices. For direct communications (also known as point-to-point communications), the participating mobile devices may tune their receivers and transmitters to the same channel(s) (e.g., one of the plurality of RF carriers of a wireless communication system or a particular RF frequency for some systems) and communicate over that channel(s). For indirect wireless communications, a mobile device may communicate directly with an associated BS (e.g., for cellular services) and/or an associated access point (AP) (e.g., for an in-home or in-building wireless network) via, an assigned channel. The BS/AP may then relay the communication to another mobile device either directly or through additional BSs/APs; etc. To complete a communication connection between mobile devices, the associated BSs and/or associated APs may communicate with each other directly, via a system controller, the public switch telephone network, the Internet, and/or some other wide area network.

To participate in wireless/mobile communications, each mobile device may include a built-in radio transceiver (i.e., receiver and transmitter), or may be coupled to an associated radio transceiver (e.g., a station for in-home and/or in-building wireless communication networks, RF modem, etc.). In most applications, radio transceivers are implemented in one or more integrated circuits (ICs), which can be inter-coupled via traces on a printed circuit board (PCB).

A transmitter aspect of the radio transceiver can include a data modulation stage, one or more intermediate frequency (IF) stages, and a PA. The data modulation stage can be configured to convert raw data into baseband signals in accordance with a particular wireless communication standard. The one or more intermediate frequency stages can be configured to mix the baseband signals with one or more local oscillations to produce RF signals. The PA can be configured to amplify the RF signals prior to transmission via an antenna.

A receiver aspect of the radio transceiver can be coupled to the antenna through an antenna interface and can include a low noise amplifier (LNA), one or more intermediate frequency stages, a filtering stage, and a data recovery stage. The LNA can be configured to receive inbound RF signals via the antenna and amplify them. The one or more IF stages can be configured to mix the amplified RF signals with one or more local oscillations to convert the amplified RF signal into baseband signals or IF signals. The filtering stage can be configured to filter the baseband signals or the IF signals to attenuate unwanted, out-of-band signals to produce filtered signals. The data recovery stage can then recover raw data from the filtered signals in accordance with the particular wireless communication standard.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram representative of an example wireless communication system in which various embodiments of the present disclosure can be utilized;

FIG. 2 is a block diagram representative of an example mobile device in which various embodiments of the present disclosure can be implemented;

FIG. 3 illustrates an example transmitter front end of the mobile device of FIG. 2 in which APT voltage setting in accordance with various embodiments of the present disclosure is implemented; and

FIG. 4 is a schematic representation and operational flow chart illustrating example processes performed for controlling supply voltage to a PA in accordance with various embodiments of the present disclosure.

### DETAILED DESCRIPTION

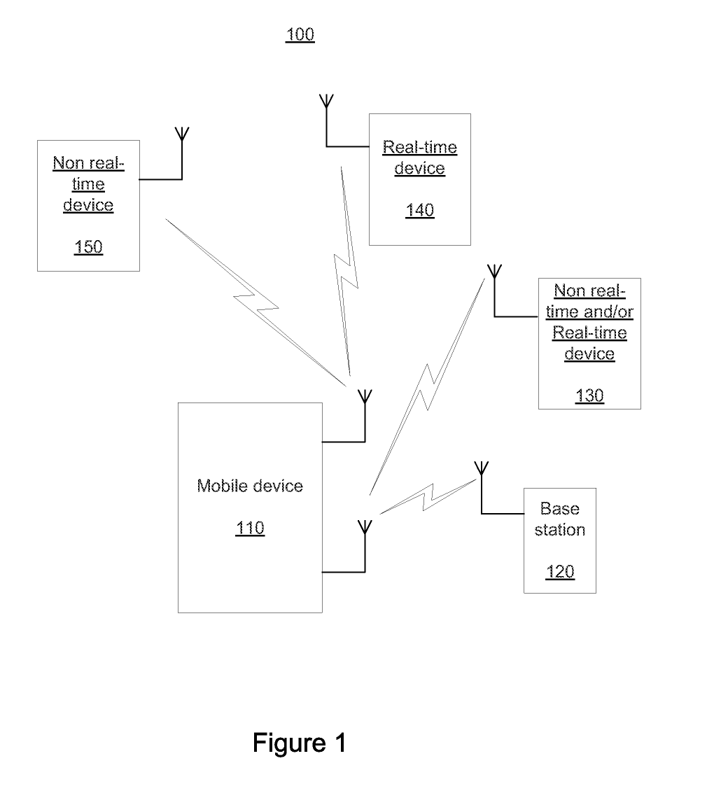

FIG. 1 illustrates an exemplary communication system in which various embodiments may be implemented. In particular, wireless communication system 100 may include a mobile device 110 that can communicate real-time data and/or non-real-time data wirelessly with one or more other devices such as base station 120, non-real-time and/or real-time device 130, real-time device 140, and/or non-real-time device 150.

Mobile device 110 may communicate with the aforementioned other devices in accordance with one or more wireless standards/protocols, including, but not limited to the following: IEEE 802.11 (e.g., WiFi™); Bluetooth®; Ultra-Wideband (UWB); WiMAX; or other wireless network protocol; a wireless telephony data/voice protocol, such as GSM; GPRS; EDGE; Personal Communication Services (PCS); LTE; or other mobile wireless protocols or wireless communication protocols. It should be noted that wireless communication paths connecting the aforementioned other devices to the mobile device 110 may include separate transmit and receive paths that use separate carrier frequencies and/or separate frequency channels. Alternatively, a single frequency or frequency channel can be used to bi-directionally communicate data to and from the mobile device 110.

Mobile device 110 may be a mobile phone, such as a cellular telephone, a PDA, game console, game device, PC, laptop computer, or other device that performs one or more functions that include communication of voice and/or data via a wireless communication path. The non-real-time and/or real-time, real-time, and non-real-time devices 130, 140, and 150 may be PCs, laptops, PDAs, mobile phones, such as cellular telephones, devices equipped with wireless local area network or Bluetooth® transceivers, FM tuners, TV tuners, digital cameras, digital camcorders, fixed and mobile location wireless communication stations such as base stations and wireless access points, or other devices that either produce, process or use audio, video signals or other data or communications.

Mobile devices, such as mobile device 110, are widely used and increasingly relied upon for business and personal communications. Additionally, mobile devices have become more feature-rich, creating the need for such mobile devices to be more powerful. That is, and in recent years, mobile devices have evolved to support more than simple data and audio communication functionality, and mobile communication systems are being designed and improved to increase die amount of efficient data exchange.

In operation, the mobile device 110 may have implemented therein, one or more applications including, but not limited to: voice communications applications, such as standard telephony applications; voice-over-Internet Protocol (VoIP) applications; local gaming; Internet gaming; email; instant and short messaging; multimedia messaging; web browsing; printing; security; e-commerce; audio/video recording; audio/video playback; audio/video downloading; streaming audio/video playback; office applications, such as databases; spreadsheets; word processing; presentation creation and processing; and/or other voice and data applications. In conjunction with these applications, real-time data may include voice, audio, video, and/or multimedia applications including Internet gaming, etc. Non-real-time data may include text messaging, email, web browsing, file uploading and/or downloading, etc.

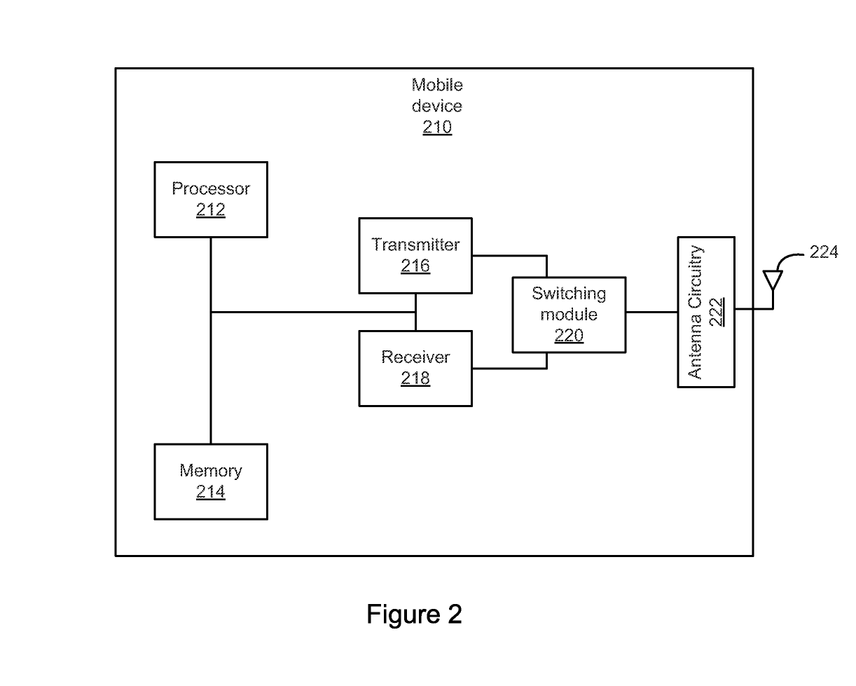

FIG. 2 is a block diagram of an example mobile device 210, which may be one embodiment of the mobile device 110, and which may be utilized in connection with various embodiments of the present disclosure. Referring to FIG. 2, mobile device 210 may include a processor 212, a memory 214, a transmitter 216, a receiver 218, a switching module 220, and antenna circuitry 222 to which at least one antenna 224 may be connected.

The mobile device 210 and its components (not all shown) may comprise suitable logic, circuitry, interfaces and/or code that may be operable to perform at the least the functions, operations and/or methods described herein. Antenna 224 may enable mobile device 210 to transmit and/or receive signals utilizing transmitter 216 and receiver 218, respectively, for example, RF signals, via a wireless communication medium. The mobile device 210 may also be depicted as comprising one or more transmitting antennas, which are coupled to the transmitter 216, and one or more receiving antennas, which may be coupled to the receiver 218 without loss of generality. The antenna circuitry 222 may include logic, circuitry, interfaces and/or code, such as a directional coupler, for example, for sensing output of a return path of antenna 224, as will be discussed in greater detail below. The switching module 220 (which can include a switch, filter and/or duplexer) can enable the antenna circuitry 222 to be communicatively coupled to the transmitter 216 or receiver 218. When the switching module 220 enables communicative coupling between the transmitter 216 and the antenna circuitry 222, antenna 224 may be utilized for transmitting signals. When the switching module 220 enables communicative coupling between the receiver 218 and the antenna circuitry 222, the antenna 224 may be utilized for receiving signals. It should be noted that mobile device 210 may utilize more than a single antenna, in which case, the antenna circuitry 222 may include logic, circuitry, interfaces and/or code for selecting an antenna over which signals may be transmitted or received.

The transmitter 216 may enable the generation of signals, which may be transmitted via antenna 224. The transmitter 216 may generate signals by performing coding functions, signal modulation and/or signal modulation

The receiver 218 may enable the processing of signals received via antenna 224. The receiver 218 may generate data based on the received signals by performing signal amplification, signal demodulation and/or decoding functions.

The processor 212, in conjunction with memory 214, may enable the generation of transmitted data and/or the processing of received data. The processor 212 may generate data, which is utilized by the transmitter 216 to generate signals. The processor 212 may further process data generated by the receiver 218.

As described above, the functionality of mobile devices has grown to include a variety of features beyond, e.g., mere voice communication. Accordingly, and to support the various functionality described above, energy efficiency has become an increasingly important design objective for mobile device manufacturers. For example, the trend toward higher data rates in an uplink path for mobile communications can result in higher power consumption by a mobile device during transmission.

Because transmission during mobile communications is becoming an increasing contributor to overall power consumption, improving transmit efficiency of a mobile device PA may be desirable. However, the high linearity requirements of existing and developing wireless communications standards impose significant operating constraints on the mobile device PA. Consequently, there remain significant challenges to providing a mobile device capable of achieving improved transmit efficiency without significantly compromising performance.

In a mobile device, the power efficiency of a PA can be increased by utilizing a technique referred to as average power tracking (APT). APT changes the DC supply voltage to the PA on a timeslot-by-timeslot basis, where the output of the PA can be a function of average power, but sufficiently “backed off” to yield acceptable error-vector magnitude (EVM) and bit error rate (BER) performance (i.e., to limit clipping RF signal peaks, which could affect the linearity of the PA). In particular, APT can be implemented using, e.g., a combination of hardware and software elements that vary the power supply voltage to the PA on a timeslot basis, in order to reduce the PA power consumption. The supply voltage to the PA may be connected to the output of a DC/DC switcher or coupler in a Power Management Unit (PMU), and this DC/DC coupler may be controlled by the voltage from a reference digital-to-analog converter (DAC). The DAC output, and as a result, the supply voltage to the PA, can be governed by a look up table (LUT). The LUT can be operated by the power of a transmit (TX) signal during each timeslot.

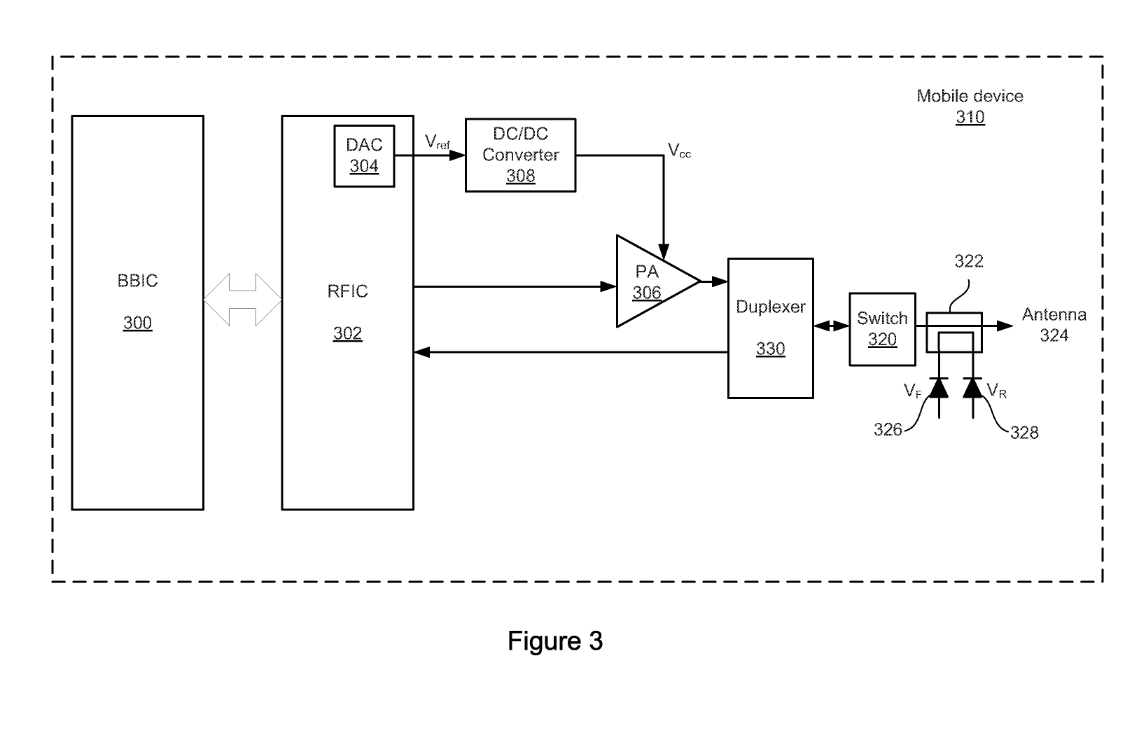

FIG. 3 illustrates an example APT implementation in a mobile device 310, which may be an embodiment of mobile device 210 of FIG. 2 and/or mobile device 110 of FIG. 1. The mobile device 310 may include baseband circuitry (shown as BBIC 300) connected to RF circuitry (shown as RFIC 302).

RFIC 302 can include a radio transceiver module for transmitting and receiving RF signals and interfaces, e.g., via a duplexer 330, switch 320, antenna circuitry 322, and antenna 324. The RFIC 302 can include an RF transmitter, e.g., transmitter 216 of FIG. 2, that transmits RF signals from the mobile device 310 to, e.g., one or more cells, BSs/APs, etc. in a wireless communications network. RFIC 302 can also include an RF receiver, e.g., receiver 218 of FIG. 2, that receives RF signals broadcast from one or more of the aforementioned cells, BSs/APs, etc. The RF transmitter and receiver of RFIC 302 may include various RF components, such as amplifiers, filters, local oscillators and mixers/modulators. In operation, the RF transmitter can modulate and up-convert a baseband signal from BBIC 300 onto an RF carrier generated by a local oscillator within the RF transmitter for RF transmission. Further, the RF receiver may filter and down-convert received RF′ signals into a signal to be processed by the BBIC 302. It should be noted that in some implementations, the RFIC 302 can include a transceiver, rather than a separate RF transmitter and RF receiver, and in still other implementations, multiple RF transmitters, receivers, transceivers, and/or antennas may be used to support multiple radio area technologies, RFIC 302 may further include a DAC module 304 for converting the baseband or low IF TX signals (from BBIC 300) from the digital domain to the analog domain. Although DAC module 304 is shown to be implemented RFIC 302, DAC module 304 may alternatively be implemented in BBIC 300.

The BBIC 300 may provide digital signal processing and control functions within the mobile device 310. The BBIC 300 can include a receive (RX) baseband module that filters and converts an analog signal received from RFIC 302 (in particular, the RF receiver) into a digital signal for further processing. The BBIC 300 may also include a TX baseband module that processes and converts a digital baseband signal into an analog signal that can be transmitted to the RFIC 302 (in particular, the RF transmitter).

To support various functions of the BBIC 300, a processor and memory, e.g., processor 212 and memory 214 of FIG. 2, respectively, can be included to interface with and control operation of other components of BBIC 300. As an example, BBIC 300 can be used to decode monitored signals received through RFIC 302, e.g., to identify a single frequency network corresponding to a cell, and may be configured to support LTE, 2G, 3G, etc., standards. The decoded signals or the raw monitored signals can be stored in the aforementioned memory. Various types of Random Access Memory (RAM) devices, Read Only Memory (ROM) devices, Flash Memory devices, and other suitable storage media can be used to implement such a memory component/module, which can store other information and data, such as instructions, software, values, and other data processed or referenced by the aforementioned processor.

PA 306 can be configured to amplify an RF signal received from RFIC 302 prior to transmission via antenna 324 in accordance with an appropriate wireless communication standard (examples of which have been provided above). Accordingly, a supply voltage to the PA 306 can be biased, where one such biasing technique can be APT (for example, when the RF signals received from RFIC 302 are encoded in accordance with CDMA standards). Thus, depending on the wireless communication standard being utilized, the wireless communication network, e.g., a BS or other “high-level” entity may set or otherwise instruct that the PA 306 of mobile device 310 amplify RF signals to obtain a certain output power level at which the RF signals are to be transmitted (by antenna 324), thereby necessitating that the supply voltage to the PA 306 be adjusted accordingly. To accomplish such adjustment to the supply voltage of the PA 306, as described above, a DC/DC converter 308 controlled by the voltage “V_{ref}” from DAC module 306, a reference DAC) can convert a power source voltage, such as a battery voltage, into a supply voltage “V_{cc}.” Using the supply voltage, PA 306 can amplify the RF signal by transferring power from the supply voltage to the RF signal in accordance with an amplifier gain (which will be discussed in greater detail below).

Duplexer 330 can be configured to separate the TX and RX signals either sent to or received from antenna 324. In order to transmit, e.g., a forward signal, and reduce the reflected signal coming from antenna 324 because of a mismatch (for example, input and output impedances are, e.g., 50 ohms), a directional coupler 322, can monitor the output signal of PA 306, and monitor the forward and reflected power (detected by “V_{F}” and “V_{R}” power detectors 326 and 328. Switch 320 can be a controllable switch that allows for either a forward-coupled port or a reverse-coupled port of directional coupler 322 to be sampled.

Current conventional mobile device platforms do not utilize “continuous” APT technology. For example, again, APT technology can be a key to lowering current consumption in a mobile device, as the use of APT can greatly reduce current consumption by dynamically reducing the supply voltage to the PA. In order to maximize the benefits that can be achieved through the use of APT, an optimal supply voltage should be supplied to the PA, where the supply voltage level supplied to the PA is aggressively low (i.e., to achieve maximum power savings), as well as robust in order to be adaptable to different variations affecting the mobile device. Such variations can include, for example, changes in peak to average power ratio (PAPR) of the transmit waveform, i.e., the difference between peak power to average power. Still other variations can include those that can occur with respect to changing conditions that can be experienced by the platform of the mobile device, e.g., temperature and frequency variations within the front-end of a transmitter, as well as load variations at the antenna.

As a result, the dynamic adjustment of the supply voltage delivered to the PA in accordance with various embodiments can be performed using an aggressive APT technique, white still maintaining/meeting performance specifications related to the transmitter. Such performance specifications can include, for example, the following: Adjacent Channel Leakage Ratio (ACLR) requirements that specify minimum ratios of an assigned channel power to an adjacent channel power, where ACLR can refer to a measure of the transmitter energy that leaks into an adjacent channel; EVM requirements to limit clipping RF signal peaks, which could affect the linearity of the PA, and TX noise in the RX band, where excessive leakage of TX noise in the RX band can cause desensitization in a mobile device.

The transmitter can perform gain changes based on taking into account one or more of the aforementioned variations, e.g., required output power, temperature, and frequency. Based on such gain changes, the supply voltage to the PA for driving the PA can be set to ultimately obtain the requisite or target output power level at which the RF signals are to be transmitted. Accordingly, a transmit gain engine can be utilized to arrive at an appropriate transmitter gain, white an APT voltage setting engine that takes into consideration the appropriate transmitter gain, and PAPR to arrive at the requisite supply voltage for the PA. Moreover, an APT voltage setting look up table (LUT) can be configured such that the aforementioned changes in transmit waveform PAPR, and changes in temperature and frequency, as well as load variations (mismatch) at the antenna level can all be taken into consideration/responded to when setting the supply voltage for the PA.

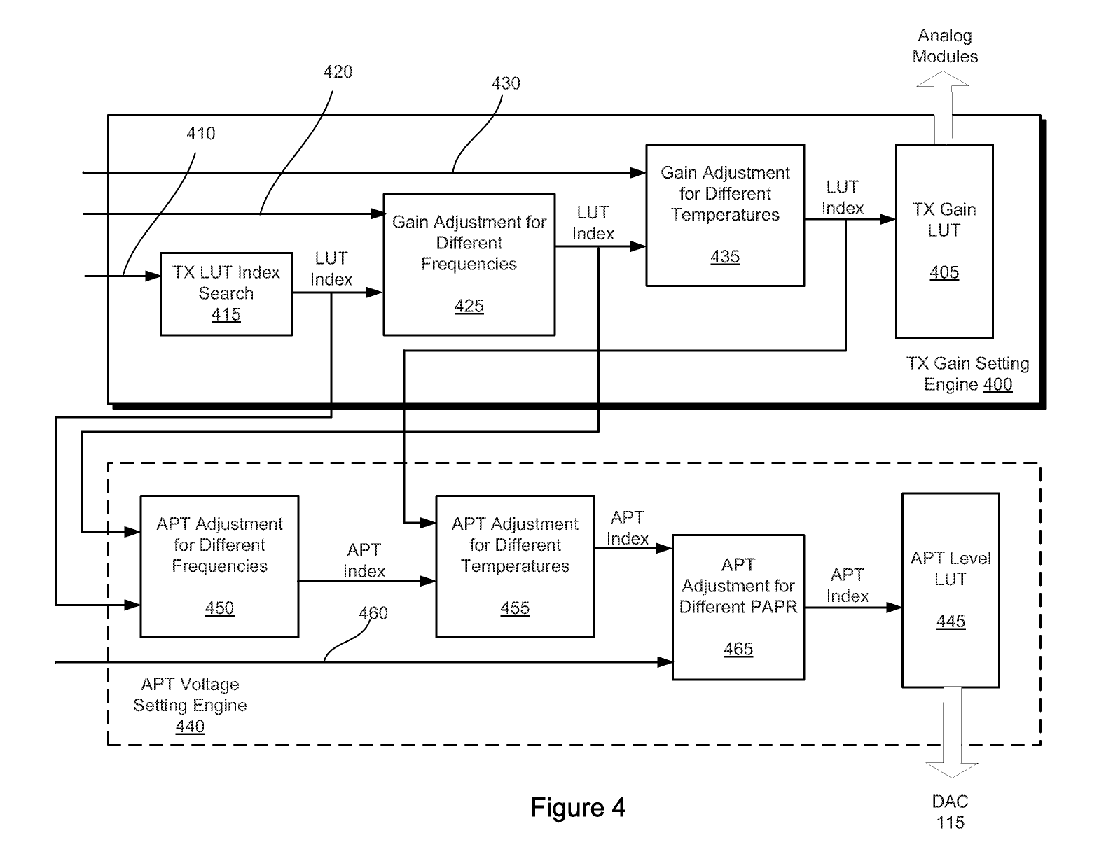

FIG. 4 is an example schematic representation and operational flow chart of a TX gain setting engine 400 and APT voltage setting engine 440 utilized in accordance with various embodiments for the dynamic adjustment of supply voltage to a PA. It should be noted that, referring back to FIG. 3, a reference DAC, e.g., DAC module 306, can be implemented in the RFIC 302 for sating the reference voltage to be converted and utilized as a supply voltage for PA 306. Accordingly, the TX gain setting engine and the APT voltage setting engine, as well as additional hardware and/or software needed to utilize and/or control such engines may be implemented in firmware running on a baseband processor, e.g., in BBIC 300.

As illustrated in FIG. 4, the TX gain setting engine 400 can rely on a TX gain LUT 405 (that has been pre-determined/previously calibrated to associate gain values with required output powers) to determine an appropriate gain setting for a required output power of a PA. Thus, the TX gain setting engine 400 can take into account the required output power 410 at which RF signals are to be transmitted from the PA, where an index search of a TX gain 435 can be performed at 415 to arrive at an indicated gain to be applied to achieve the required output power 410. That is, the required output power 410 can be utilized as an index into the TX gain LUT 435 to determine the gain to be applied, where the TX gain LUT 435 can store a table listing each required output power level as corresponding to a particular gain.

Additionally, to compensate for the frequency (band/channel) 420 at which the PA is operating, the aforementioned firmware can determine how to adjust the determined gain according to frequency at 425. Therefore, anew, frequency-adjusted output power can be determined, and this new frequency-adjusted output power can be utilized as an index into the TX gain LUT 435 to determine a frequency-adjusted gain. For example, there may be an increased drop of, e.g., 2 dB, going from a first frequency to a second frequency. Accordingly, to maintain the required output power 410, the PA must be driven at a higher power to compensate for this drop. Once the firmware determines this higher power, this higher power, in turn, can be utilized as an index into the TX gain LUT 405 to determine a new, frequency-adjusted gain to be applied.

Additionally still, and regarding temperature, the firmware may determine how to adjust this latest determined frequency-adjusted gain to compensate for temperature variation(s) that can be experienced by the mobile device platform. That is, as temperature rises, the output power of the PA generally decreases, while as temperature drops, the output power of the PA generally increases. Accordingly, to maintain the required output power 410, the power of the PA must be adjusted depending on the temperature 430, resulting in yet another new, temperature-adjusted output power determined by the firmware, which again, can be utilized as an index into the TX gain LUT 405 to determine anew, temperature-adjusted gain to be applied. As illustrated in FIG. 4, the temperature-adjusted gain may then be sent/applied to the analog modules of the mobile device, such as the RF circuitry, e.g., RFIC 302 of FIG. 3. Therefore, utilization of the TX gain setting engine 400 can result in determining an optimized gain that compensates for both temperature and frequency variation(s) to achieve a required output power of the PA.

Regarding the APT voltage setting engine 440, an APT level LUT 445 that can indicate pre-determined/calculated APT voltage levels (i.e., supply voltages to the PA adjusted in accordance with APT as previously described) as corresponding to peak power values. The APT level LUT 445 can be constructed, such that for each possible band, an APT voltage level is specified as corresponding to a peak power value. Each peak power value within the APT level LUT 445 can correspond to a maximum power point in the band, as well as worst case scenarios for different temperatures.

Moreover, each APT voltage level corresponding to a peak power value may include a “margin” to account for worst load impedance/Voltage Standing Wave Ratio (VSWR) conditions. That is, a goal in antenna usage is to match impedance/remove mismatch loss, such that the power reflected from the load/antenna is reduced, thereby maximizing the power (from the PA) delivered to the antenna, VSWR is a function of the reflection coefficient, which describes the power reflected from the antenna. Hence, each APT voltage level can compensate for worst case scenarios regarding toad variation at the antenna. For example, ACLR requirements can be violated if a PA is designed for, e.g., 50Ω output loading, and the antenna is not. To compensate for the mismatch, the APT voltage level should be adjusted.

In operation, and based on the required output power, and the frequency-adjusted output power determined in the TX gain setting engine 400, the firmware can make APT voltage level adjustments for different frequencies at 450 in the APT voltage setting engine 440. That is, and because the response of the post-PA elements of the mobile device (front end), e.g., duplexer 330 and switch 320, the APT voltage level is not flat, and because the APT voltage level can be a function of the output power determined (as described above) by the TX gain setting engine 400, a frequency correction algorithm can be utilized to adjust the required output power of the PA to compensate for different frequencies. Similarly to how the frequency-adjusted output power determined in the TX gain setting engine 400 can be utilized as an index to the TX gain LUT 405 to determine a frequency-adjusted gain, the frequency-adjusted output power determined at 450 can be used as an index to the APT level LUT 445 to determine a new, frequency-adjusted APT voltage level.

Additionally, the temperature-adjusted output power determined at the TX gain setting engine 400 can be utilized in the APT voltage setting engine 440, where a temperature correction algorithm can be used further adjust the frequency-adjusted output power determined at 450 in accordance with different temperatures at 455. Again, this now, temperature-adjusted output power determined at 455 can be used as an index to the APT level 445 to determine a new, temperature-adjusted APT voltage level.

Further still, and for every (RF signal) TX waveform and target TX root-mean-square (rms) power (provided by, e.g., a BS, as described above), the expected TX peak power within the time slot (using the TX waveform profile) can be pre-calculated. This can greatly reduce the APT level LUT 445/storage complexity as well as characterization/calibration time. Using the combination of both the target TX rms power and the expected TX peak power, adjustments can be made for changes in the PAPR of the TX waveform at 465, and the PAPR-adjusted output power can be utilized as an index to the APT level LUT 445 to determine an optimal supply voltage that should be delivered to the PA. Accordingly, this optimal supply voltage can be forwarded to DAC module 306 of FIG. 3, which as described above is a reference DAC for setting the reference voltage to DC/DC converter 308, which can convert the power supply voltage to the required APT-adjusted supply voltage to drive PA 306. It should be noted that while various embodiments have been described in the context of utilizing PAPR, as a measurement of the TX waveform, peak-to-average (PAR) can also be utilized. That is, and white PAPR can be defined as the peak amplitude of a waveform squared (giving peak power) divided by the rms value of the waveform squared (giving average power), PAR is calculated from the peak amplitude of a waveform divided by the rms value of the waveform.

Configuring APT voltage levels in accordance with various embodiments can outperform “brute-force” APT implementations in terms of current savings, as such brute-force APT implementations require the use of large margins to account for PAPR variations, temperature variations, frequency variations, and load variations. Moreover, such brute-force APT implementations may require more calibration steps to compensate for PAPR variations on standard TX waveforms. In contrast, configuring APT voltage levels in accordance with various embodiments can result in optimal/preferred APT voltage levels under any of the aforementioned conditions (i.e., temperature, frequency, PAPR, and load variations) and does not require any additional calibration steps due to the use of the APT level LUT.

For example, configuring APT voltage levels in accordance with various embodiments can lower the current consumption in the mobile device platform by approximately 10 mA compared to a brute-force APT implementation, and can do so without additional cost or calibration time. Given that the total current consumption of a mobile device platform (e.g., the RFIC, the BBIC, and the PMU) can reach approximately 1.00 mA in a typical voice call scenario, this additional 10 mA saving can be significantly advantageous.

It should be noted that the various embodiments disclosed herein can be applied to any/all cellular systems (such as 3G, 4G LTE, etc.) as well as other wireless systems with relatively high output transmit power (such as WLAN and 60 GHz communication systems).

The various diagrams illustrating various embodiments may depict an example architectural or other configuration for the various embodiments, which is done to aid in understanding the features and functionality that can be included in those embodiments. The present disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement various embodiments. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

It should be understood that the various features, aspects and/or functionality described in one or more of the individual embodiments are not limited in their applicability to the particular embodiment with which they are described, but instead can be applied, alone or in various combinations, to one or more of the other embodiments, whether or not such embodiments are described and whether or not such features, aspects and/or functionality is presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Moreover, various embodiments described herein are described in the general context of method steps or processes, which may be implemented in one embodiment by a computer program product, embodied in, e.g., anon-transitory computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

As used herein, the term module can describe a given unit of functionality that can be performed in accordance with one or more embodiments. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality. Where components or modules of the invention are implemented in whole or in part using software, in one embodiment, these software elements can be implemented to operate with a computing or processing module capable of carrying out the functionality described with respect thereto. The presence of broadening words and phrases such as “one or more,” “at least,” “but not limited to” or other like phrases in some instances shall not be read to mean that the narrower case is intended or required in instances where such broadening phrases may be absent.

1. A method, comprising:
performing at least one gain adjustment to achieve an output power of a power amplifier (PA) for amplifying a radio frequency (RF) signal; and
performing at least one average power tracking (APT) adjustment, based on the at least one gain adjustment to derive a supply voltage at which to drive the PA.

2. The method of claim 1, wherein the performing of the at least one gain adjustment comprises adjusting the required output power based on a change in temperature.

3. The method of claim 2, wherein the performing of the at least one APT adjustment comprises adjusting the supply voltage based on the change in temperature.

4. The method of claim 1, wherein the performing of the at least one gain adjustment comprises adjusting the required output power based on a change in frequency.

5. The method of claim 4, wherein the performing of the at least one APT adjustment comprises adjusting the supply voltage based on the change in frequency.

6. The method of claim 1, wherein the performing of the at least one APT adjustment comprises adjusting the supply voltage based on a change in one of peak to average power ratio (PAPR) and peak to average ratio (PAR) of a transmit waveform associated with the RF signal.

7. The method of claim 1, wherein the deriving of the supply voltage comprises selecting the supply voltage from a look up table (LUT), wherein the supply voltage includes a margin to compensate for load variation of an antenna driven by the PA.

8. The method of claim 7 further comprising, measuring reflected power at the antenna to determine the load variation utilizing a directional coupler module and a power detector module.

9. The method of claim 1 further comprising, sending the supply voltage to a digital to analog converter (DAC).

10. The method of claim 9 further comprising, converting the supply voltage via a direct current to direct current (DC/DC) converter prior to driving the PA.

11-20. (canceled)
